(19) United States
(12) Patent Application Publication
(10) Pub. No.: US 2006/0031345 A1
(43) Pub. Date: Feb. 9, 2006

(54) Mail system for transmitting instant message and method of the same

(75) Inventors: Ming-Chih Chang, Taipei (TW); Kuei-Fu Hsu, Linkou Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QNAP System Inc.

(21) Appl. No.: 11/024,096

(22) Filed: Dec. 28, 2004

(30) Foreign Application Priority Data
Jun. 21, 2004 (TW) 93117855

(51) Int. Cl. G06F 15/16

(52) U.S. Cl. 709/206

(57) ABSTRACT

A mail system for transmitting instant message and method of the same is disclosed. The system comprises a mail servo module, a message protocol module, and a message conversion module. When receiving a message from a client unit, the message conversion module converts the message as a message readable for the mail servo module according to the message protocol module, and transfers the converted message to the mail servo module, and the mail servo module replies an interactive operation corresponding to the converted message. When receiving a message from the mail servo module, the message conversion module converts the message as a message readable for the client unit according to the message protocol module, and transfers the converted message to the client unit.

### BACKGROUND

The present invention relates to a data processing method and system, and in particular to a mail system with an instant message transmission function and the processing method thereof.

E-mail has gradually replaced conventional letters for communication. Recently, instant message applications, having real-time reaction and convenience, are popular for widely used in contacting remote users, even providing parts of mail functions for transferring text and files.

For current mail systems, mail checking is performed periodically by mail systems, or is executed voluntarily by users. The time that users receive mails is determined by time interval or the setting time of mail server checking, resulting in inconvenience for users and waste of time. In addition, the increasing frequency affects server performance, resulting in system lag. Some messages with prescription should be reacted instantly, and, however, current mail systems cannot achieve such performance.

Therefore, a mail system with an instant message transmission function is desirable to solve the described problems.

### SUMMARY

Accordingly, an object of the invention is to provide a mail system, communicating with client units using instant messages via an adapter.

Another object of the invention is to provide a processing method for a mail system with an instant message function, converting messages from different communication platforms to messages readable for a mail system, and the mail system thus replies an operation corresponding the message.

According to the object described, an embodiment of the invention discloses a mail system with an instant message function, comprising at least a client unit, a mail servo module, a message protocol module, and a message conversion module, in which the message protocol module comprises a plurality of message protocols.

The message conversion module receives a message from the client unit and identifies the client unit according to the message protocol module. The message conversion module then determines whether the client unit has registered to the mail servo module. If the client unit has registered, the message from the client unit is converted to a message readable for the mail servo module, and the converted message is transferred to the mail servo module, or the message is abandoned and the connection to the client unit is terminated.

The message conversion module receives a message request from the mail servo module, obtains a username corresponding to the message request according to the message protocol module. The message conversion module then determines whether a desired client unit is on-line. If the client unit is on-line, a message from the mail servo module is converted to a message readable for the client unit and is transferred to the client unit, or a failed response is returned to the mail servo module.

Also disclosed is a processing method for a mail system with an instant message function. A message request from a mail servo module is received and a username corresponding to the message request is obtained according to a message protocol module. It is determined whether a desired client unit is on-line. If so, a message from the mail servo module is converted to a message readable for the client unit, the converted message is forwarded to the client unit, and a successful response is then returned to the mail servo module. If not, a failed response is returned to the mail servo module.

Further disclosed is a processing method for a mail system with an instant message function. A message is received from a client unit and the client unit is identified according to a message protocol module. It is determined whether the client unit has registered to a mail servo module. If so, the message from the client unit is converted to a message readable for the mail servo module and the converted message is forwarded to the mail servo module, and, if not, the message is abandoned and the connection to the client unit is terminated.

In addition, the client unit can further input at least one control command by a command line interpreter (CLI) to send messages for enabling the mail servo module to reply the control command corresponding to the messages.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing the architecture of the mail system of an embodiment of the invention;

FIG. 2A is flowchart showing the method of an embodiment of the invention, in which the client unit sends messages to the mail system;

FIG. 2B is flowchart showing the method of an embodiment of the invention, in which the mail system sends messages to the client unit;

FIG. 3 is a schematic diagram of the messages from the mail system of an embodiment of the invention, in which each message corresponds to a control command; and

FIGS. 4A˜4C are schematic diagrams showing interactions between the client unit and the mail system of an embodiment of the invention, in which the client unit input commands that enables the mail system to respond corresponding operations.

### DETAILED DESCRIPTION

The present invention discloses a mail system with an instant message function and processing method thereof.

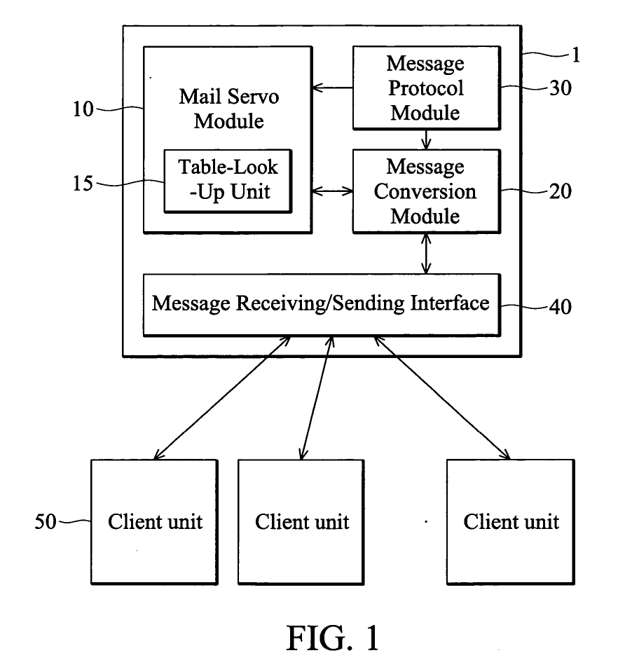

FIG. 1 is a schematic diagram showing the architecture of the mail system of an embodiment of the invention.

Mail system 1 of the invention comprises a mail servo module 10, a message conversion module 20, a message protocol module 30, message receiving/sending interface 40, and at least one client unit 50, in which message protocol module 30 comprises a plurality of message protocols.

Message conversion module 20 receives a message from client unit 50 through message receiving/sending interface 40 and identifies client unit 50 according to the message protocol module 30. Message conversion module 20 then determines whether client unit 50 has registered to mail servo module 10 according to a table-look-up unit 15. If client unit 50 has registered, the message from client unit 50 is converted to a message readable for mail servo module 10, and the converted message is transferred to mail servo module 10, or the message is abandoned and the connection to client unit 50 is terminated.

Message conversion module 20 receives a message request from mail servo module 10, obtains a username corresponding to message request 50 according to the message protocol module 30. Message conversion module 20 then determines whether a desired client unit 50 is on-line. If client unit 50 is on-line, a message from mail servo module 10 is converted to a message readable for client unit 50, and the converted message is transferred to client unit 50, or a failed response is returned to mail servo module 10.

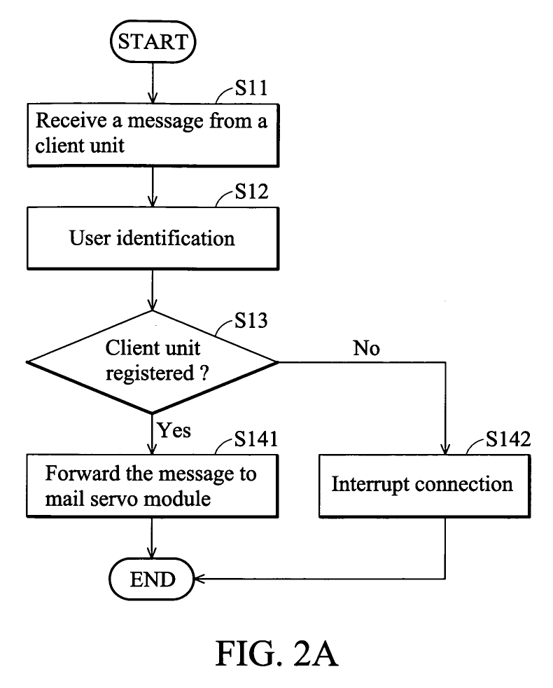

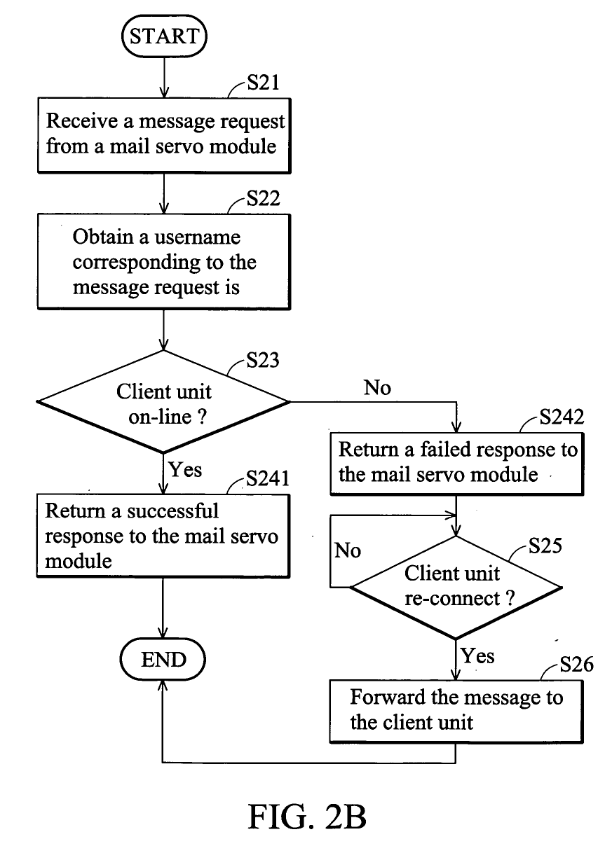

FIG. 2A is flowchart showing the method of an embodiment of the invention, in which the client sends messages to the mail system.

In step S11, a message is received from a client unit.

In step S12, the client unit is identified according to a message protocol module.

In step S13, it is determined whether the client unit has registered to a mail servo module. If so, the process goes to step S141, and, if not, to step S142.

In step S141, the message from the client unit is converted to a message readable for the mail servo module and the converted message is forwarded to the mail servo module, replying an operation corresponding to the message.

In step S142, the message is abandoned and the connection to the client unit is terminated.

FIG. 2B is flowchart showing the method of an embodiment of the invention, in which the mail system sends messages to the client unit.

In step S21, a message request from a mail servo module is received.

In step S22, a username corresponding to the message request is obtained according to a message protocol module.

In step S23, it is determined whether a desired client unit is on-line. If so, the process goes to step S241, and, if not, to step S522.

In step S241, a message from the mail servo module is converted to a message readable for the client unit, the converted message is forwarded to the client unit, and a successful response is then returned to the mail servo module.

In step S242, a failed response is returned to the mail servo module.

In addition, the client unit can input at least one command by a command line interpreter (CLI) to send messages for enabling the mail servo module to reply the control command corresponding to the messages.

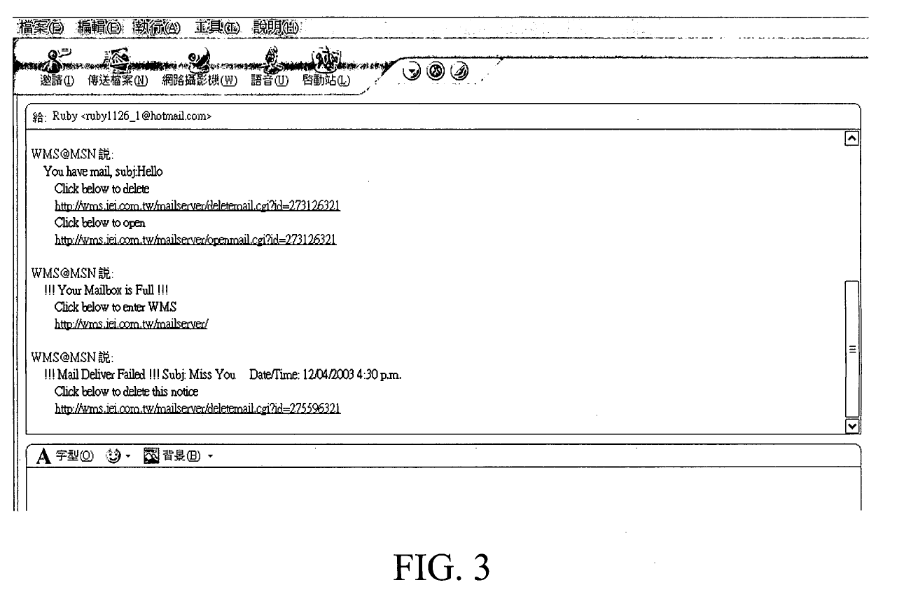

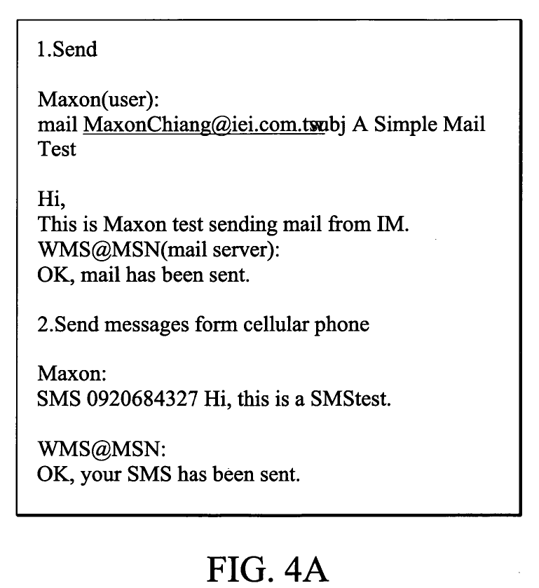

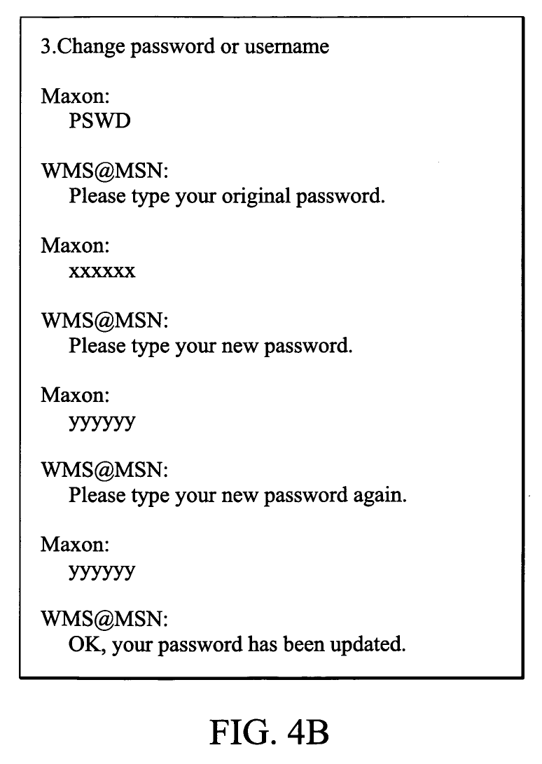

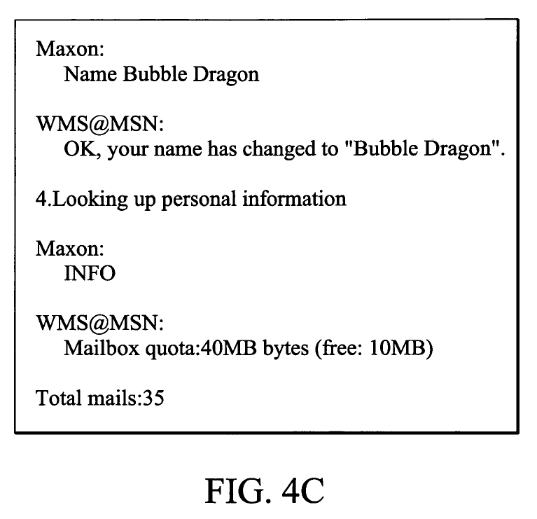

FIG. 3 is a schematic diagram of the messages from the mail system of an embodiment of the invention, in which each message corresponds to a client unit operation. A mail system with an instant message function sends a message to a client unit immediately when receiving mails for the client unit, enabling the client unit to respond a proper operation (as described in the step S21˜S241), such as deleting, opening, downloading replying, or forwarding. In addition, the mail system also transfers system responses to the client unit, for example, full capacity, system maintaining, and failed sending.

In addition, current system configuration states, for example, insufficient capacity of mailbox, system maintenance, or sending failed, must be informed of the client unit. When a desired client unit is off-line, the mail system records messages for the client unit and forwards the messages while the client unit reconnects (as described in the step S25˜S26). The mail system also could converts the message into an email for sending while the client unit is off-line.

An instant message adapter can be an interface of a mail system due to its convenience, providing a command line interpreter for client units to input control commands (as described in the step S11˜S141), causing corresponding operations from the mail system, in which the operations include looking up data, setting or inquiring system parameters, and setting accounts. Client units also can send messages using a mail system with communication devices. Interactions between a mail system and a client unit are shown in FIGS. 2A˜2C.

An embodiment of the invention enables client units using incompatible message applications to communicate with each other via an instant message adapter, convenient and practical for client units.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mail system for transmitting or receiving an instant message between at least one client unit and a server unit, the mail system comprising:
a message protocol module coupled to the client unit for providing a plurality of message protocols to enable the client unit to communicate with the server unit using one of the message protocols corresponding to the client unit;
a mail servo module coupled to the server unit and the message protocol module for transmitting or receiving the instant messages using the message protocols; and
a message conversion module coupled to the message protocol nodule and the mail servo module for converting the message to a message which is readable for the mail servo module according to the message protocol module to transfer the converted message to the mail servo module so that the mail servo module responds to the converted message to generate an interactive operation upon receiving a message from the client unit, and converting the message to a message readable for the client unit according to the message protocol module to transfer the converted message to the client unit upon receiving a message from the mail servo module.

2. The system as claimed in claim 1, wherein the message conversion module receives a message request from the mail servo module, obtains a username corresponding to the message request according to the message protocol module to determine whether a desired client unit is on-line, and forwards the message from the mail servo module to the client unit if the client unit is on-line, or returns a failed response to the mail servo module.

3. The system as claimed in claim 2, wherein the message conversion module returns a successful response to the mail servo module after forwarding the message from the mail servo module to the client unit.

4. The system as claimed in claim 1, wherein the message conversion module receives the message from the client unit, identifies the client unit according to the message protocol module to determine whether the client unit has registered to the mail servo module, and forwards the message from the client unit to the mail servo module if the client unit has registered, or abandons the message and terminates the connection to the client unit.

5. The system as claimed in claim 4, wherein the client unit further comprises a command line interpreter (CLI) to input at least one control command and the mail servo module replies the control command.

6. The system as claimed in claim 1, wherein the message conversion module determines a communication platform at which the client unit is located according to the message protocol module.

7. The system as claimed in claim 1, wherein the interactive operation is the one selected from a group consisting of mail deletion, mail management, read/deletion of the message reply, virus-infected mail deletion, and system maintenance.

8. A processing method for a mail system capable of transmitting instant message, the processing method comprising the steps of:
receiving a message request from a mail servo module;
obtaining a username corresponding to the message request according to a message protocol module;
determining whether a desired client unit is on-line; and
transferring a message from the mail servo module to the client unit if the client unit is on-line, or returning a failed response to the mail servo module.

9. The method as claimed in claim 8, further comprising the step of converting the message to a message that is readable for the mail servo module according to the message protocol module before transferring a message from the mail servo module to the client unit.

10. The method as claimed in claim 8, wherein a successful response is returned to the mail servo module after transferring a message from the mail servo module to the client unit.

11. The method as claimed in claim 8, wherein the message protocol module comprises a plurality of message protocols.

12. The method as claimed in claim 8, during the step of obtaining a username corresponding to the message request, a communication platform at which the client unit is located is determined according to the message protocol module.

13. The method as claimed in claim 8, wherein the client unit is acquired????? by a table-look-up unit during the step of obtaining a username corresponding to the message request.

14. A processing method for a mail system capable of transmitting an instant message, the processing method comprising the steps of:
receiving a message from a client unit;
identifying the client unit according to an message conversion module;
determining whether the client unit has registered to a mail servo module;
transferring the message from the client unit to the mail servo module if the client unit has registered, or abandoning the message and terminating the connection to the client unit.

15. The method as claimed in claim 14, before transferring the message from the client unit to the mail servo module, further comprising step of converting the message to a message readable for the mail servo module according to the message protocol module so that the mail servo module replies to the converted message to generate an interactive operation.

16. The method as claimed in claim 14, wherein the message protocol module comprises a plurality of message protocols.

17. The method as claimed in claim 14, wherein during the step of obtaining a username corresponding to the message request, a communication platform at which the client unit is located is determined according to the message protocol module.

18. The system as claimed in claim 14, wherein the interactive operation is the one selected from a group consisting of deleting mails, managing mails, reading/deleting the reply messages, deleting virus-infected mails, and maintaining the system.

19. The method as claimed in claim 18, further comprising step of inputting at least one control command by a command line interpreter (CLI) to enable the mail servo module reply the control command.

20. The method as claimed in claim 18, wherein the client unit is acquired????? by a table-look-up unit during the step of obtaining a username corresponding to the message request.
